(19) United States
(12) Patent Application Publication
(10) Pub. No.: US 2007/0269044 A1
(43) Pub. Date: Nov. 22, 2007

(54) DIGITAL LIBRARY SYSTEM WITH RIGHTS-MANAGED ACCESS

(76) Inventor: Michael A. Bruestle, Stuttgart (DE)

Correspondence Address: Stephen B. Salai, Esq.;Harter, Secrest & Emery LLP, 1600 Bausch & Lomb Place, Rochester, NY, 14604-2711, US

(21) Appl. No.: 11/422,354

(22) Filed: Jun. 6, 2006

Related U.S. Application Data
(60) Provisional application No. 60/747,341, filed on May 16, 2006.

(51) Int. Cl. G09C 5/00

(52) U.S. Cl. 380/54

(57) ABSTRACT

A management system for a worldwide digital library provides for the unfettered distribution of copyright-free materials while protecting and enforcing owner's rights with respect to the distribution of copyright-protected works. End users with local devices operating with trusted computing environments, which can limit the further storage or use of delivered materials, can be granted access to the copyright-protected works under the conditions set by the owners.

### FIELD OF THE INVENTION

The invention relates to library systems containing collections or having access to collections of works maintained in a machine-readable form and to management systems for making the collections available to library clients in a human-readable form while protecting ownership rights associated with the works.

### BACKGROUND AND SUMMARY OF THE INVENTION

Much of recorded human knowledge is held in books and other media that exist in limited quantities or locations or whose existence is inadequately documented. Many such works are at risk of loss by accident, war, or neglect. New knowledge is also appearing in forms that are not systematically preserved or made permanently accessible.

A digital library can now be envisioned for preserving and distributing a comprehensive worldwide collection of the published works of mankind including books, newspapers, and magazines, audio, video, graphics, multimedia, and other data forms originally published on tangible mediums as well as electronically published works often referred to as “born digital” materials. Preserving and distributing the published works of generations of mankind together with the accumulation and distribution of new works as they are published would encourage a more rapid advancement of the cultural, intellectual, and scientific aspirations of current and future generations.

Such a digital library would render the works more consistently machine readable, whereby search engines or other data-mining tools capable of full text, bibliographic, or other forms of inquiry could be used to locate works of interest. Open-source bibliographic metadata standards would aid in the development of machine-searching techniques as well as catalogues for satisfying long-term preservation needs. Copies of the works or information about them could then be made more widely available in human-readable forms.

Both the initial collection of the works and any subsequent presentation or distribution of the collected works should respect the rights of owners and creators of the works. Unencumbered access can be provided for works that are freely available to the public. However, copyright protected or other lawfully restricted works should be maintained in a secure environment and access to such works should be limited in keeping with the wishes of the owners and creators of the works.

Many conventional libraries have a special interest in digitizing their collections of older materials that are beyond the reach of copyright laws for preserving and making their collections more accessible to their clients. Publishers of copyright-protected works, while well aware of the possibility for electronic distribution of their published works, are often reluctant to electronically distribute their works because of concerns over unauthorized copying. Thus, a secure management system is needed to regulate the electronic distribution and subsequent use of copyright-protected works or other works under the lawful control of their owners.

The machine-readable database, which is preferably in a digital form, can reside in a single location or in multiple locations. The databases in multiple locations are preferably accessible within a network through common, shared, or open protocols. In fact, a comprehensive worldwide digital library could be assembled from a plurality of networks including a library network linking libraries of the world, a publisher network linking publishers of the world, a political network linking national and international institutions, and a commercial network linking businesses. One or more duplicate databases limited to local access could be used for long-term preservation of the works. The works themselves are preferably stored with or linked to bibliographic and other metadata containing information about the works such as logical or physical structures of the works, administrative, descriptive or technical data, and instructions from the copyright owners.

Thus, a comprehensive worldwide digital library can be assembled or grown from individual digital collections so linked as to support search and retrieval functions. A data management system can provide for distributing both copyright-protected and copyright-free works from the collections. For example, a digital rights management system can be used to limit the access, distribution, and other use of copyright-protected or other lawfully restricted materials and to support a commercial framework whereby the owners of the copyright-protected works can be compensated for the use of their works.

The invention in one or more of its envisioned embodiments contemplates a method of making digital copyright-protected and copyright-free works available to a plurality of clients having local devices that enforce policies of a digital rights management system. Access is obtained to one or more digital library collections including digital copyright-protected and copyright-free works. A set of rights obtained from the owners of the copyright-protected works is associated with their digital copyright-protected works, including one or more rights with respect to the sale, distribution, and terms of use of the digital copyright-protected works. An order placed by one of the clients for access to at least a portion of one of the digital copyright-protected works can be responded to by distributing the ordered portion of the digital copyright-protected work to the one client in a secure form through the digital rights management system in exchange for consideration. The consideration is collected from the one client, and a portion of the consideration is paid to the owner of the accessed work. An order placed by the same or a different one of the clients for access to at least a portion of one of the digital copyright-free works can be responded to by distributing the ordered portion of the digital copyright-free work to the same or a different one of the clients. The distribution of the digital copyright-protected works is limited to the plurality of clients having local devices that enforce policies of the digital rights management system for regulating further use of the distributed digital copyright-protected works while permitting a range of less regulated to unregulated further use of the distributed digital copyright-free works to the plurality of clients.

The digital copyright-protected works are maintained in a secure environment and the distribution of the digital copyright-protected works is regulated in accordance with the associated set of rights obtained from the owners of the digital copyright-protected works. The digital rights management system preferably includes components that are embedded within the local devices of the clients.

Responding to an order placed by one of the clients for access to at least a portion of one of the digital copyright-protected works preferably includes delivering permission instructions to a local device of the client for regulating further use of the distributed digital copyright-protected work that is granted to the client. The permission instructions can be based on the copyright owners' terms of use and can be contained within metadata that is linked to the digital copyright-protected works. The metadata can be embedded within encrypted digital copyright-protected works for distribution to the clients or maintained separately from the digital copyright-protected works and encrypted together with the digital copyright-protected works for distribution to the plurality of clients.

The digital copyright owners' terms of use can include different specifications for different locations. For example, the locations of the local devices can be reported, and the permission instructions delivered to the local devices can incorporate specifications of the digital copyright owners' terms of use for the reported locations. The locations can differ by being within and without a given library system, and the permissions can differ for the digital copyright-protected works delivered within and without the given library system. The permissions can also differ between countries. The digital copyright owners' terms of use can also include different specifications for different clients. For example the clients can be registered for different levels of access.

Preferably, the digital copyright-protected and copyright-free works are arranged in a searchable form including metadata that contains terms for delivering limited portions of the digital copyright-protected works to the clients in response to search inquiries. Searching capabilities can be provided to the clients for accessing information about the digital works in varying amounts based on the digital copyright owners' terms of use or other legal rights. For example, metadata that contains the digital copyright owners' terms of use can be accessed for regulating the amounts of information that are made available about the digital copyright-protected works. The digital copyright-protected and copyright-free works can be arranged into a searchable form that includes incorporating a structural analysis of physical or logical structures of the works. The structural analysis preferably includes distinguishing text from graphics as well as distinguishing sectional divisions of the works. Arranging the digital copyright-protected and copyright-free works into a searchable form preferably includes forming bibliographic inventories including text, graphics, audio, video, and multimedia works.

In addition, the one or more digital library collections including digital copyright-protected and copyright-free works are preferably preserved in a separate secure database for long-term storage and cultural preservation. The digital copyright-protected and copyright-free works can be stored within the separate secure database in an open-standard format. The digital copyright-protected and copyright-free works are preferably stored within the separate, secure database without digital rights management restrictions.

A watermark or other encoded information can be embedded into the distributed digital copyright-protected works for distribution to the plurality of clients. The digital copyright-free works can be distributed to additional clients having local devices that do not enforce policies of the digital rights management system. The digital copyright-free works and the digital copyright-protected works whose distribution is not restricted by their copyright owners are preferably delivered to the clients free of charge.

Another embodiment of the invention contemplates a method of operating a library system for sharing access to digital copyright-protected works among clients of the library system. The digital copyright-protected works are maintained in a secure environment. Applicable permissions obtained under the copyright laws are associated with the digital copyright-protected works. Local devices are arranged in a network governed by a digital rights management system. A request for access to one of the digital copyright-protected works from one of the clients is responded to by delivering a limited portion of the requested digital copyright-protected work in a secure form to one of the local devices for display to the one client. A request for access to the same digital copyright-protected work from another of the clients is responded to by delivering a different limited portion of the requested digital copyright-protected work in a secure form to another of the local devices for display to the other client. The portions of the digital copyright-protected works on display by the local devices are monitored to prevent the same portion of the digital copyright-protected work from being simultaneously displayed on more local devices than allowed by the permissions obtained under of the copyright laws for the associated digital copyright-protected work.

In this way, libraries can more efficiently make available digital copyright-protected works to their clients. Different portions of the same copyright-protected work can be made available to more than one client simultaneously. Client access to the different portions of the same copyright-protected work can be monitored to make sure more clients than permitted under the rights obtained from the copyright owner are not accessing that same portion of a copyright-protected work.

Components of the digital rights management system are preferably embedded in the local devices to enforce policies of the digital rights management system for regulating further use of the digital copyright-protected works on display by the local devices. In addition to delivering portions of digital copyright-protected works in response to requests, permission instructions are preferably delivered to the local devices for regulating further use of the delivered portions of the digital copyright-protected works.

The portions of the digital copyright-protected works on display by the local devices are preferably monitored to prevent the same portion of the digital copyright-protected work from being simultaneously displayed on more local devices than permitted under the rights obtained from the owners of the digital copyright-protected works. Requests from other clients for accessing the same portion of the digital copyright-protected work can be rejected.

The number of requests for the same portion of a digital copyright-protected work can be monitored for evaluating a need to obtain additional permissions from the owner. In addition, the clients making the requests can be notified of the multiple requests made by other clients for such purposes of arranging the clients in a queue for accessing the same portion of the copyright-protected work.

Yet another embodiment of the invention contemplates providing limited access to copyright-protected works within a digital library system in accordance with fair-use provisions of relevant copyright laws. Requests by remote users for access to portions of copyright-protected works stored in digital library system are processed. For each request, a relevant jurisdiction is ascertained and a determination is made if fair-use provisions of the relevant jurisdiction govern the request. The user is granted access to the requested portion of the copyrighted work without compensating the owner of the work when the request is governed by the fair-use provisions of the relevant jurisdiction and the user is denied access to the requested portion of the copyrighted work without compensating the owner of the work when the request is not governed by the fair-use provisions of the relevant jurisdiction.

For ascertaining the relevant jurisdiction, a physical location of the remote user can be ascertained or a physical location from which access to the requested portion of the copyrighted work is to be granted can be ascertained. The accompanying determination can include determining if national laws over the relevant jurisdiction include applicable fair-use provisions.

In addition, the determination can involve how much of the requested portion of the copyright protected work can be lawfully accessed under the fair-use provisions of the relevant jurisdiction. Thus, when granting access, the user can be granted access to less than all of the requested portion of the copyrighted work in accordance with the amount of the copyright protected work can be lawfully accessed under the fair-use provisions of the relevant jurisdiction.

### BRIEF DESCRIPTION OF THE SEVERAL VIEWS OF THE DRAWINGS

FIG. 1 is a diagram showing the collection of published works for a digital library.

FIG. 2 is a flow diagram showing processing steps involved in the construction of a digital library.

FIG. 3 is a flow diagram showing an overall framework for the digital library.

### DETAILED DESCRIPTION OF THE INVENTION

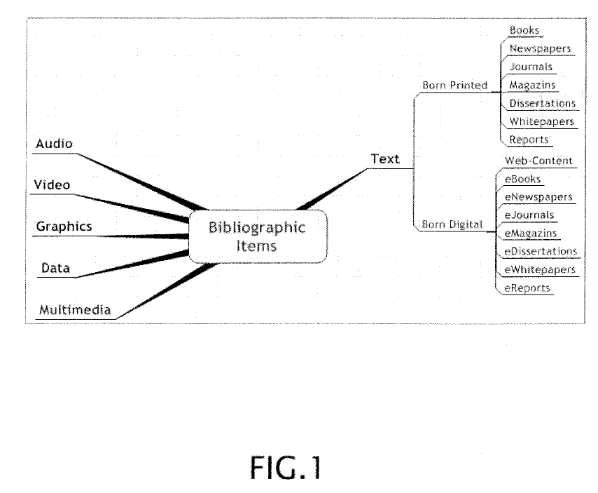

As illustrated in FIG. 1, the invention contemplates collecting the published works of mankind, including such works in the form of text, such as books, newspapers, journals, magazines, dissertations, whitepapers, and reports or in the form of audio, video, graphics, multimedia, and other data structures published on tangible mediums as well as electronically published works often referred to as “born digital” materials. Such “born digital” materials include web content, eBooks, eNewspapers, ejournals, eDissertations, ewhitepapers, and eReports. The collection of published works, however, is maintained in a digital form, meaning that the works are contained in a form that is machine-readable for more rapid processing by machines such as computers. Provisions must also be made for the distribution of the collected works in a more human-accessible form.

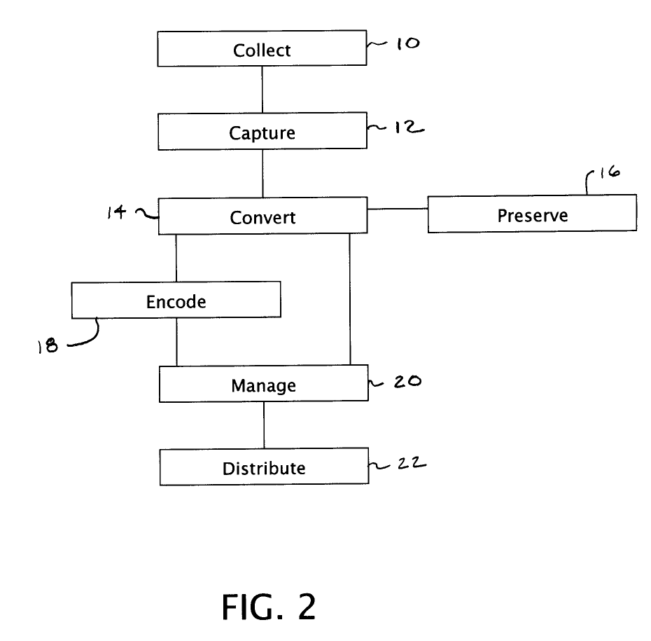

Constructing a working digital library requires a number of additional processing steps such as depicted in FIG. 2. For instance, in addition to collecting the works as indicated at 10, the works must be captured in a machine-readable form as indicated at 12. The source materials used for capturing are preferably original publications but can also be taken from copies on other media, such as archival microfilm, where the original copies are not available. The capture mode, such as scanning, and the capture form, including such issues as color depth and resolution, can be set to meet targeted results. However, the outcome of the capture procedure is preferably a non-compressed or at least a loss-free form of compressed data. For example, the capture of electronic images of individual pages are preferred to preserve the form in which the works were originally presented.

A conversion process as indicated at 14 is key to interpreting the captured works. For example, a collection of digital objects built for search and retrieval needs searchable metadata about its objects. Such metadata including descriptive, administrative, and technical metadata, as well as structure-logical and structure-physical metadata, reference important information about the sources beyond the pure textual or bitmapped information immediately extractable from the sources. A variety of different competitive models for metadata description exist. Most have in common some form of a preservation strategy. International standards for such metadata structures are evolving, and the transformation of one metadata format structure into another is possible in most cases.

Worldwide, many major libraries and universities are cooperating in the development of appropriate metadata standards. The Library of Congress in the United States of America has been one of the leading organizations advocating such cooperation. The favored metadata structures are based on open standards and are useable by the general public without royalty obligations. Similarly, the programming language for using the metadata structures is preferably based on open standards and should not be limited to a particular operating system.

The first step within the conversion process of text-based materials is preferably a type of image pre-processing, which may also be executed during capturing. Each individual scanned page is, as far as necessary, electronically cleansed, de-skewed, de-speckled, and cropped, and coherent pages are checked for missing or double pages. The file numbers of the scanned pages, for example of a monograph, are brought in the correct order according to the original. The latter task is especially important if the scanning has been performed manually.

Following image pre-processing, a layout analysis can be made in which the captured image of each page is divided into blocks with different content, including (a) text blocks containing paragraphs, tables, formulae or the like and (b) non-text blocks containing graphics and other non-character based information. The individual text blocks can be transferred to an OCR (optical character recognition) engine that translates images of the text blocks into machine-readable text. However, the optical character recognition step could be performed first followed by analyzing the layout and creating the structure in a following step, such as by using contextual awareness search technologies, text and data mining tools, and linguistic search algorithms. Built-in corrective functions within the OCR engine can eliminate scanning detection and transformation errors. Suitable software tools, partly based on rules that describe certain groups of documents, such as books, encyclopedia, and other references, can be used to detect the physical and logical structures of the complete documents. While the physical structure analysis more or less describes only text and graphics blocks, the logical structure analysis detects the content and indicates its relation to the complete context. From the logical structure, a text block can be recognized, for example, as a table of contents, a summary, a chapter headline, a chapter paragraph, a footnote, an appendix, or a bibliography. The physical description can be carried out if necessary down to character level and can indicate size, font, and even the coordinates of every letter. Normally these software tools offer options to carry out manual correction steps on different execution levels. Many different methods and execution possibilities exist which are described in various publications including patents such as U.S. Pat. No. 6,907,431 to Lin, U.S. Pat. Nos. 5,784,487 and 6,377,704 to Cooperman, US Patent Application Publication No. 2003/0204816 of Simard et al., and US Patent Application Publication No. 2004/0139384 of Lin, which are all hereby incorporated for reference.

The captured and converted works together with their associated metadata are preferably stored in electronic databases for purposes of both preservation and use. For example, one version of the electronic database is preferably set aside for purposes of long-term preservation of its contents as indicated at 16, and another version of the electronic database, which is intended for lawful dissemination, is modified by encoding the copyright-protected or other lawfully restricted materials within the database as indicated at 18. For purposes of long-term preservation, especially for national libraries, the captured and converted works should be stored completely uncompressed and in the highest resolution possible from the production process. By contrast, the use of this material for search and display does not necessarily require a high resolution rate of its data. The works, therefore, can be stored in a compressed or even lossy form within the electronic database intended for dissemination to save storage space and improve the system performance.

The electronic format adopted for purposes of preservation is preferably an open standard not dependent upon particular programming languages or operating systems. In addition, the database set aside for preservation is preferably not accessible to outside users. However, the preservation-dedicated database is preferably arranged to grow with the capture and conversion of new works, preferably by stand-alone additions that do not alter any prior contents.

Within the electronic database intended for dissemination, the copyright-free works can be stored in a number of different environments including a trusted computing environment such as a “Digital Library Management Application” (DLNA) or in other computing environments in a plain, non-proprietary data format, such as Extensible Markup Language (XML). However, the copyright-protected works, which include works subject to lawful restrictions, are preferably stored in an encoded form within a trusted computing environment accessible through a Digital Rights Management (DRM) system of an operating system or through an application of a DLNA protected by a DRM system.

Under management protocols indicated at 20, the integrity of the entire electronic database is preferably protected against unauthorized access or tampering, but the copyright-protected material is further secured from unauthorized access. Web-based queries for distributing information in the electronic database as indicated at 22 can be distinguished between browsers operating within a trusted computing environment from those operating outside a trusted computing environment. Standard web browsers operating outside the trusted computing environment would not have the capability to read or decode the protected materials. However, limited search capabilities and restricted displays of results from the copyright-protected materials are possible in keeping with applicable laws and permissions of the copyright owners. Any such protected material would require translation into a format manageable by a standard web browser. Web browsers operating within trusted computing environments can be granted further access to the copyright-protected materials including possibilities for decoding the protected materials. The electronic databases for forming a digital library can be dispersed over different locations around the world but are preferably linked together by meta-search engines and data management systems through which the contents of the databases can be lawfully distributed.

A chief concern for administering such a digital library involves the need to obey all lawful restrictions to the dissemination of information from the electronic databases. Copyright protection rules are fairly similar worldwide, due to several international copyright treaties, the most important of which is the Berne Convention (The Berne Convention for The Protection of Literary and Artistic Work), which from 1886 has undergone multiple revisions—Berlin [1908], Rome [1928] Brussels [1948], Stockholm [1967] and Paris [1971]). Country-specific provisions, for example setting the period after which a copyright-protected work becomes the property of the public (“public domain”), differ and must also be taken into account.

Many nation-specific clauses exist regarding copyrights, particularly about the question whether and on which scale abstracts of protected works may be legally copied or published. This issue is important to the design of a digital library that is accessible worldwide over the Internet. For example, a digital library that strictly obeys all national laws according to the provisions of its native country can still contribute to violating copyright laws of other countries.

A worldwide digital library in accordance with a preferred embodiment of the invention is one that is widely accessible yet restricts access to lawfully protected works in accordance with all applicable laws and the lawful intentions of the owners of copyright-protected works. A user or client can be required to pass a personalized login procedure to access the contents of the digital library from beyond the library's physical boundaries or control, such as from a user's home or business. A variety of technical solutions and devices are available for encoding or otherwise protecting the contents of the digital library from unauthorised access. An umbrella definition for these solutions has been termed as a “Digital Rights Management System” (DRM). For example, proprietary software programs are available that permit observation of a file but refuse printing or storing. U.S. Pat. No. 6,948,073 to England et al., which is hereby incorporated by reference, describes an enforcement architecture and method for protecting digital content accessible over the Internet. Public or Intranet Web services are available in which decision criteria use transport layer confidentiality with HTTPS and (Username) Token support for authentication. Symmetric or asymmetric (public/private key) encryption can be used to keep messages confidential and safe from unintended tampering.

For disseminating copyright-free information, the preferred invention seeks to avoid proprietary data formats in combination with any DRM for privately securing the files and data unless such formats can be accommodated by standard Internet browsers. For disseminating copyright-protected information, the preferred invention seeks regulate not only the initial dissemination of copyright-protected works but also their further use. Most conventional encryption schemes still permit everything that can be displayed on a computer screen to be stored or printed, and even those schemes that restrict storing or printing can be easily circumvented by available software tools. Although illegal, an unrestricted and unchecked distribution of copyright protected material would be the unwelcome consequence.

Pure software solutions are expected to be vulnerable to attacks. However, a combination of hardware (HW) and operating system (OS) measures both incorporating “roots of trust”, beside others, can provide computing environments in which exclusive permissions to access shielded locations (e.g. memory, register, etc.) can be granted. Substantial developments in the area of trusted computing environments and trusted collaboration between computing platforms have been made by the “Trusted Computing Platform Alliance” (TCPA), now the “Trusted Computing Group” (TCG), including as members AMD, Hewlett-Packard, IBM, Infineon, Intel, Lenovo, Microsoft, and Sun Microsystems.

Programs embedding DRM systems, e.g. by using the aforementioned authentication and identification procedures, and which rely on trusted computing environments, e.g. according to the specifications of the TCPA, cannot be similarly circumvented by the end-users. The preferred embodiment of the invention provides for creating digital libraries in such trusted computing environments with embedded DRM systems. At least the copyright-protected items are marked with additional metadata that contains all the respective information according to the lawful restrictions and terms of use specified by the copyright owners.

The copyright metadata can include, among others, the following specifications:
search access rights—e.g., who is entitled to search,
metadata display—e.g., how much information about the documents can be viewed as primary hit result to the query and by whom,
document display—e.g., how much of the document content can be viewed, under what conditions, and by whom,
pricing—e.g., who and how much is charged what for which content, for which additional rights, and
additional rights—e.g., under what conditions can the document be stored and/or printed, how often, how long, by whom, etc.

The DRM system in a trusted computing environment makes it possible to determine within the “Digital Library Management Application” (DLMA) the terms of use for every copyright protected work of the library according to individual or collective agreements with the respective copyright owners and to connect this information inseparably with the data files containing the protected works. The integration of the DRM within the operating system, enables restrictions on the further use of information transferred to the end-user. Any forbidden printout, electronic copy, paste, or save operation can be blocked. Even possible payment model information can be inseparably connected to the data. The “Digital Library End-User Application” (DLEUA), which can be either a part of the operating system OS or a separate application, but which is embedded in the DRM system of the OS, handles the access to the copyright protected materials.

If a query to the DLMA, which can preferably be performed by any web-browser, originates from a local device that does not support a trusted computing environment, then the DLMA can be arranged to only allow the access to copyright-free material. Standard web-browsers, unlike browsers in a trusted computing environment, do have the capability to read (decode) the protected material. However, depending on the specifications of the right holder, a limited search capability and a limited display of results regarding the copyright-protected materials could be released to local devices without restriction. In this case, the DLMA translates the protected content, strictly according to the specifications of the rights owners, to a plain format, e.g. XML. However, the released information would be reduced considerably for access by an “insecure system”, since further restrictions cannot be enforced regarding the subsequent use of the decoded information.

If the rights owners' specifications allow, the end user could be granted the unlimited and unrestricted right over a document. This information recorded in the associated metadata would allow either the DLMA or the DLEUA to decode the content into plain, non-protected material. This conversion process can be performed with or without watermarking the document.

A number of patent publications assigned to Microsoft Corporation describe structures methods for implementing and exploiting capabilities of digital rights management (DRM) systems. The following table lists such publications, which are hereby incorporated by reference.

| US Application | |
|---|---|
| No. | Title |
| 2005 0060549 | Controlling access to contend based on certificates and |
| | access predicates |
| 2004 0243836 | Hierarchical trusted code for content protection in |
| | computers |
| 2004 0181487 | Digital media clearing house platform |
| 2004 0172533 | Tying a digital license to a user and tying the user |
| | to multiple computing devices in a DRM system |
| 2004 0168077 | Issuing a DRM license for content based on cross-forest |
| | directory information |
| 2004 0168073 | Issuing a publisher use license off-line in a DRM system |
| 2004 0168061 | Enrolling/sub-enrolling a DRM server into DRM |
| | architecture |
| 2004 0158731 | Publishing digital content within a defined universe |
| | such as an organization in accordance with a DRM |
| | system |
| 2004 0034770 | Method and system for using a web service license |
| 2004 0003271 | Providing a secure hardware identifier for use in |
| | connection with DRM system |
| 2004 0003270 | Obtaining a signed rights label for digital content and |
| | obtaining a digital license to the content based on the |
| | SRL . . . |
| 2004 0003269 | System and methods for issuing usage licenses for digital |
| | content and services |
| 2003 0233561 | Publishing content in connection with DRM architecture |
| 2003 0195855 | DRM encryption and data-protection for content on |
| | device without interactive authentication |
| 2005 0244008 | Protecting decrypted compressed content and decrypted |
| | decompressed content at a DRM client |
| 2005 0187879 | Persistent license for stored content |
| 2005 0175224 | Desynchronized fingerprinting method and system for |
| | digital multimedia data |
| 2005 0165690 | Watermarking via quantization of rational statistics of |
| | regions |
| 2005 0125352 | Method for lifetime tracking of intellectual property |
| 2005 0108556 | System and method for accessing protected content in |
| | a rights-management architecture |
| 2003 0149618 | Flexible dynamic advertising |

From an information architecture perspective, the main physical entities and their relationship with other entities in a DRM-system are:
Content Server (Content Repository)
License Server (key repository, user identity database, license generator)
Client

The Content Server encapsulates information including the digital material, its attributes, the policies, and eventually the code necessary to enable the operation. The information can be stored by the Content Server in an encypted form, or the Content Server can encrypt the information at the time the information leaves the Server. One party can make the information available to another party with an authenticated identity for obtaining access and use according to particular rules. Once the content, the identity of the user, and the rules are in alignment, which can be handled and coordinated by the License Server, a DRM transaction can proceed. This overall structure is based on recommendations introduced e.g. by Gladney, H. M; and Lotspiech, J. B. from the IBM Alamaden Research Center “Safeguarding Digital Library Contents and Users” in D-Lib Magazine Vol. 3 No. 5, May 1997. Mark Stefik from Xerox has described (Stefik, M.; “Trusted Systems” in Scientific American, March 1997) how the concept of trusted systems can be expanded into an architecture for access management that also emphasizes technical enforcement.

In addition to these more technically oriented provisions, additional goals for improving the security of the system and the infrastructure have been set, including:
preserving privacy, backward compatibility and owner control,
promoting ease-of-use,
designing the technology so that it is interoperable.

One of the leading advocates for so-called “Trusted Computing” is the Trusted Computing Group, who develop and publish respective best practice principles on design, implementation and usage. A problem with some DRM-systems that enable access to and presentation of the information in a computer environment, even if they run in a protected mode by using a proprietary encoding software, is their vulnerablily to third-party piracy programs capable of storing the information in an open, no-longer protected format. For digital images as well as for audio and video data, there is, therefore, often an additional watermarking technology used to secretly mark the data. This eventually enables the content owners to trace back the spur to the violator. However, single watermarking for textual material is not feasible as by copying and reformatting the watermarks would be destroyed.

At the instigation of the movie industry and backed by computer hardware and software producers, a new HDCP standard (High-Bandwidth Digital Content Protection) has been devised for home entertainment high definition videos (HD). HDCP is a digital rights management system developed by the Intel Corporation to control digital audio and video content. All hardware devices receiving the encrypted data must conform with a protection schema to decode and display the information. The HDCP system requires users (clients) to buy new, HDCP-compliant hardware. DRM systems combining both such hardware and software can be used can also be used to control the display and further use of copyrighted materials.

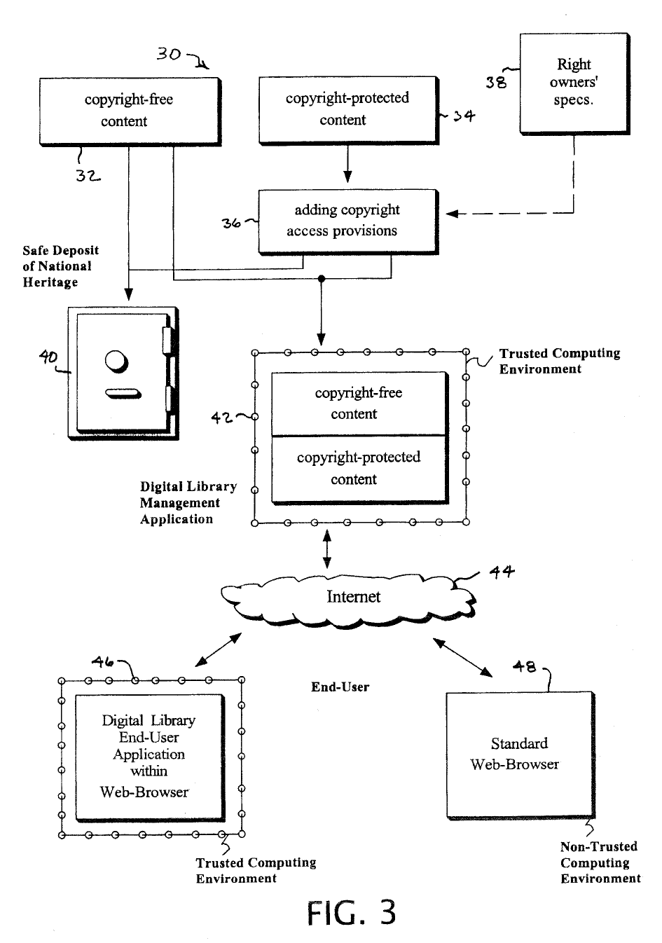

An overview of a management system 30 for the digital library is shown in FIG. 3. The library content, including both copyright-free materials 32 and copyright-protected materials 34, is preferably acquired in an open, non-proprietary data format, e.g. TIFF for the scan images and XML for text and metadata. Rights and restrictions 36 associated with the copyright-protected materials and garnered from their lawful owners 38 are also preferably acquired in an open, non-proprietary data format, e.g. XML.

The library content 32, 34, and 36 together with its associated metadata in and open, non-proprietary format is stored in one or more separate protected databases 40 for long-term preservation. The protected database is not accessible to outside users, and remains under the control of a limited group of people charged with its preservation for current and future generations.

For purposes of long-term preservation, all digitized material including all of the respective metadata associated with the materials are preferably separately stored in a non-proprietary way (text and metadata both e.g. in XML and the images e.g. in TIFF). The separate databases must be stored at a very secure location, preferably without any online access. For at least the textual material, these locations could be the national libraries of respective countries.

The same library content 32, 34, and 36 is required to pass through a digital library management application (DLMA) 42 to become available to the larger public, particularly through networked connections such as the Internet 44. Within a trusted computing environment, the copyright-free content 32 is preferably retained in an open, non-proprietary data format. However, the copyright-protected content 34 is preferably encoded in proprietary data format protectable within a digital rights management (DRM) system. For example the copyright-protected content can be encrypted such as by enciphering or scrambling the data under prescribed methodologies or by putting the data under the surveillance of the DRM system, which can prevent a user form accessing the data in an open readable form (e.g., XML) and can manage all access rights.

Two classes of end user or client can interface with the digital library management application for accessing the contents of the digital library. End users 46 operating within a trusted computing environment under a digital library end-user application (DLEUA) are granted access to both the copyright-free content 32 and the copyright-protected content 34, the latter according to assess-right and payment provisions 36 associated with the copyright-protected materials. End users 48 operating outside a trusted computing environment are granted access to the copyright-free materials 32 and any of the copyright-protected materials 34 or portions thereof for which dissemination rights have already been granted by their owners.

The end-users 46 operating within the trusted computing environment are distinguished by local devices within which digital rights management controls are embedded. These controls restrict the further duplication and use of the accessed copyright-protected materials, except under the lawful conditions specified by the access provisions 36 associated with the materials. Under the specified provisions, the end users 46 can purchase or otherwise acquire the rights to such further use.

Since further use beyond initial access can be limited, governments can consider enacting more uniform provisions for initially accessing copyright-protected works to balance societal interests to disseminate information with societal interests to incentivize its creation. For example, the users 46 operating within a trusted computing environment could be entitled to browse through copyright-protected material for purposes of privately reading, listening to, or viewing the copyright-protected material. However, the number of instances of access could be limited along with instances of further use. Scholarship or research exceptions could be made regarding either access or further use, which could be established on an accountable basis. Such rights would not be acquired merely at the discretion of the end-user but with permissions granted through the overall digital rights management system.

Even under current law, the preferred digital library systems envisioned by the invention provide accessibility to the digital library database with virtually any Internet browser. If the digital library management application (DLMA) receives a search inquiry from a browser that does not support the digital rights management DRM system, the DLMA will nevertheless perform an answer, which could hint at the copyright-protected material or perhaps even more, according to the provisions released from the copyright owner. Access to the copyright-protected materials themselves would remain prohibited as long as the end-user performs the inquiry from an Internet browser outside the digital rights management DRM system. However, latter end-user may be entitled to have access to a small portion of a protected work within the envisioned digital library system according to the “fair-use” provisions of the country from which the end-user is performing his inquiry, as long as the country of origin for the inquiry can be detected unequivocally. By contrast, in countries which do not provide such fair-use regulations in their copyright laws, or when the country of origin is not detectable, end-users performing their inquiry from an Internet browser outside the digital rights management DRM system may not have access to even the small portions of the protected works.

This fair-use approach also applies to users performing their inquiries from Internet browsers inside the digital rights management DRM system. That is, even when content owners prohibit any access to their content without liability to pay, fair-use regulations may be applicable in certain countries, particularly with respect to the content of published works. In all other countries access to the same limited content may be blocked by the digital rights management system.

Copyright owners can only be expected to give their consent for the incorporation of their work into such a digital library when the library and all its computer systems respect, obey, and enforce their legal copyrights. The more the digital library enforces the law, the more the library will attract further authors and publishers, and by that way grow its collection.

Such a DLMA/DLEUA-system relying on a hardware and software supported DRM system can also manage various location-specific or national interests. For example, regional/national differences can be as well taken into account regarding the copyright protection and national security issues can also be accommodated for limiting access or dissemination of certain types of information. For example, in a country where the copyright lasts for only 50 years, a local user 48 could freely access the work after 50 years; but by contrast, a user 48 in another country with a 70-year copyright protection term would not yet be granted unrestricted access to the work.

The DLMA/DLEUA-system relying on a hardware and software supported DRM system can also manage various different access rights granted to the clients. Information identifying the clients and their access rights to the copyright protected materials can be specified in the metadata and registration procedures can be followed for establishing identity or clearance level.

As a further protective measure, text watermarking could be applied to the copyright-protected materials. Within the trusted computing environment, legal printouts could be permanently personalized and, if necessary, later assigned to the respective end-user.

The invention also contemplates the possibility of establishing intra-library systems, which according to local law provisions, can be made accessible without any restriction to users within the library. This is similar to today's regulations with printed books, where any user can have unrestricted access to any book on the library shelf. The in-house computer user get unrestricted electronic access to any item which is physically available in this library, but with limited printing or storing capabilities. Even inter-library loans can be performed with this system. As long as a work is lent electronically to another library, the online access to this work could be closed in the lending library, according to the respective national copyright and fair-use regulations.

From within a library system, a request for access to one of the digital copyright-protected works from one of the clients can be responded to by delivering a limited portion of the requested digital copyright-protected work in a secure form to one of the local devices for display to the one client. A request for access to the same digital copyright-protected work from another of the clients can be responded to by delivering a different limited portion of the requested digital copyright-protected work in a secure form to another of the local devices for display to the other client. The different portions of the digital copyright-protected works on display by the local devices can be monitored to prevent the same portion of the digital copyright-protected work from being simultaneously displayed on more local devices than permitted under the requirements of the copyright laws applicable to the digital copyright-protected work.

Components of the digital rights management system can be embedded in the local devices to enforce policies of the digital rights management system for regulating further use of the digital copyright-protected works on display by the local devices. This would enable the local devices to be located beyond the physical control of the library system. Thus, in addition to delivering portions of digital copyright-protected works, permission instructions could be delivered to the local devices for regulating further use of the delivered portions of the digital copyright-protected works.

The portions of the digital copyright-protected works on display by the local devices could be monitored to prevent the same portion of the digital copyright-protected work from being simultaneously displayed on more local devices than permitted under the rights obtained from the owners of the digital copyright-protected works. Requests from additional clients for access to the same portion of the digital copyright-protected work could be rejected to avoid displaying the work on more than the maximum number of local devices permitted under the rights obtained from the owners of the digital copyright-protected works. Clients making the additional requests could be notified of their status awaiting the disengagement of another client's access to the work. Time constraints regarding client access could also be imposed, especially if other clients are awaiting access. The number of requests for the same portion of a digital copyright-protected work could be monitored for evaluating a need to obtain additional permissions from the owner.

Although described with respect to a limited number of embodiments, those of skill in the art will appreciate the many particular variations that can be made within the overall teaching of the invention.

1. A method of making digital copyright-protected and copyright-free works available to a plurality of clients having local devices that enforce policies of a digital rights management system comprising steps of
obtaining access to one or more digital library collections including digital copyright-protected and copyright-free works,
associating a set of rights obtained from the owners of the digital copyright-protected works with their digital copyright-protected works, including one or more rights with respect to the sale, distribution, and terms of use of the digital copyright-protected works,
responding to an order placed by one of the clients for access to at least a portion of one of the digital copyright-protected works by distributing the ordered portion of the digital copyright-protected work to the one client in a secure form through the digital rights management system in exchange for consideration,
collecting the consideration from the one client,
paying a portion of the consideration to the owner of the accessed work,
responding to an order placed by the same or a different one of the clients for access to at least a portion of one of the digital copyright-free works by distributing the ordered portion of the digital copyright-free work to the same or a different one of the clients, and
limiting the distribution of the digital copyright-protected works to the plurality of clients having local devices that enforce policies of the digital rights management system for regulating further use of the distributed digital copyright-protected works while permitting a range of less regulated to unregulated further use of the distributed digital copyright-free works to the plurality of clients.

2. The method of claim 1 in which the digital copyright-protected works are maintained in a secure environment and the distribution of the digital copyright-protected works is regulated in accordance with the associated set of rights obtained from the owners of the digital copyright-protected works.

3. The method of claim 2 in which the digital rights management system includes components that are embedded within the local devices of the clients.

4. The method of claim 1 in which the step of responding to an order placed by one of the clients for access to at least a portion of one of the digital copyright-protected works includes delivering permission instructions to a local device of the client for regulating further use of the distributed digital copyright-protected work that is granted to the client.

5. The method of claim 4 in which the permission instructions are based on the copyright owners' terms of use.

6. The method of claim 5 in which the permission instructions are contained within metadata that is linked to the digital copyright-protected works.

7. The method of claim 6 in which the metadata is embedded within encrypted digital copyright-protected works for distribution to the clients.

8. The method of claim 6 in which the metadata is maintained separately from the digital copyright-protected works and is encrypted together with the digital copyright-protected works for distribution to the plurality of clients.

9. The method of claim 5 in which the digital copyright owners' terms of use include different specifications for different locations.

10. The method of claim 9 in which the locations of the local devices are reported and the permission instructions delivered to the local devices incorporate specifications of the digital copyright owners' terms of use for the reported locations.

11. The method of claim 10 in which the locations differ by being within and without a given library system and the permissions differ for the digital copyright-protected works delivered within and without a given library system.

12. The method of claim 10 in which the permissions differ between countries.

13. The method of claim 5 in which the digital copyright owners' terms of use include different specifications for different clients.

14. The method of claim 13 in which the different clients are registered with different access rights.

15. The method of claim 1 including a step of arranging the digital copyright-protected and copyright-free works into a searchable form including metadata that contains the digital copyright owners' terms for delivering limited portions of the digital copyright-protected works to the clients in response to search inquiries.

16. The method of claim 15 including a step of providing searching capabilities to the clients for accessing information about the digital works in varying amounts based on the digital copyright owners' terms of use.

17. The method of claim 15 in which the step of providing searching capabilities includes accessing the metadata that contains the digital copyright owners' terms of use for regulating the amounts of information that are made available about the digital copyright-protected works.

18. The method of claim 15 in which the step of arranging the digital copyright-protected and copyright-free works into a searchable form includes incorporating a structural analysis of a physical and logical structure of the works.

19. The method of claim 18 in which the sub-step of incorporating the structural analysis includes distinguishing text from graphics.

20. The method of claim 18 in which the sub-step of incorporating the structural analysis includes distinguishing sectional divisions of the works.

21. The method of claim 15 in which the step of arranging the digital copyright-protected and copyright-free works into a searchable form includes forming bibliographic inventories including text, graphics, audio, video, and multimedia works.

22. The method of claim 1 including a step of preserving the one or more digital library collections including digital copyright-protected and copyright-free works in a separate secure database for long-term storage and for cultural preservation.

23. The method of claim 22 in which the digital copyright-protected and copyright-free works are stored within the separate secure database in an open-standard format.

24. The method of claim 23 in which the digital copyright-protected and copyright-free works are stored within the separate secure database without digital rights management restrictions.

25. The method of claim 1 including a step of embedding a watermark or other encoded information into the distributed digital copyright-protected works.

26. The method of claim 1 including a step of supporting the distribution of the digital copyright-free works to additional clients having local devices that do not enforce policies of the digital rights management system.

27. The method of claim 26 in which the step of supporting includes supporting the distribution of digital copyright-protected works, whose distribution is not restricted by their copyright owners, to the additional clients having the local devices that do not enforce the policies of the digital rights management system.

28. The method of claim 27 in which the digital copyright-free works and the digital copyright-protected works whose distribution is not restricted by their copyright owners are delivered to the clients free of charge.

29. A method of operating a library system for sharing access to digital copyright-protected works among clients of the library system comprising steps of
maintaining the digital copyright-protected works in a secure environment,
associating permissions obtained under copyright laws to the digital copyright-protected works,
arranging a plurality of local devices in a network governed by a digital rights management system,
responding to a request for access to one of the digital copyright-protected works from one of the clients by delivering a limited portion of the requested digital copyright-protected work in a secure form to one of the local devices for display to the one client,
responding to a request for access to the same digital copyright-protected work from another of the clients by delivering a different limited portion of the requested digital copyright-protected work in a secure form to another of the local devices for display to the other client, and
monitoring the portions of the digital copyright-protected works on display by the local devices to prevent the same portion of the digital copyright-protected work from being simultaneously displayed on more local devices than allowed by the permissions obtained under the copyright laws for the associated digital copyright-protected work.

30. The method of claim 29 in which the step of arranging includes embedding components of the digital rights management system in the local devices to enforce policies of the digital rights management system for regulating further use of the digital copyright-protected works on display by the local devices.

31. The method of claim 30 in which the steps of responding to requests include, in addition to delivering portions of digital copyright-protected works, delivering permission instructions to the local devices for regulating further use of the delivered portions of the digital copyright-protected works.

32. The method of claim 29 in which the step of associating applicable permissions obtained under the copyright laws to the digital copyright-protected works includes associating rights obtained from the owners of the digital copyright-protected works with their digital copyright-protected works.

33. The method of claim 32 in which the step of monitoring the portions of the digital copyright-protected works on display by the local devices includes preventing the same portion of the digital copyright-protected work from being simultaneously displayed on more local devices than allowed by the permissions obtained from the owners of the digital copyright-protected works.

34. The method of claim 33 in which the step of monitoring the portions of the digital copyright-protected works on display by the local devices includes rejecting a request from another of the clients for accessing the same portion of the digital copyright-protected work being simultaneously displayed to the maximum number of local devices allowed by the permissions obtained from the owners of the digital copyright-protected works.

35. The method of claim 29 in which the step of monitoring the portions of the digital copyright-protected works on display by the local devices includes monitoring the number of requests for the same portion of a digital copyright-protected work for evaluating a need to obtain additional permissions from the owner.

36. The method of claim 35 including a step of obtaining additional permissions from the owner of a copyright for simultaneously displaying the same portion of the owner's digital copyright-protected work on one or more additional local devices.

37. The method of claim 29 including a step responding to multiple requests for the same portion of a digital copyright-protected document by notifying at least one of the clients making the requests of the multiple requests.

38. The method of claim 29 including a step responding to multiple requests for the same portion of a digital copyright-protected document by imposing a limitation on the display of the digital copyright-protected work by one or more of the local devices.

39. A method of governing access to a collection of published works stored in a machine-readable format comprising steps of
distinguishing lawfully protected and lawfully unprotected works within the collection,
associating terms of use obtained from the lawful owners of the lawfully protected works with the lawfully protected works,
providing access to the lawfully protected works through a plurality of local devices operating within a trusted computing environment for restricting further use of the lawfully protected works in accordance with the terms of use obtained from the lawful owners of the works,
providing access to the lawfully unprotected works through an expanded plurality of local devices not limited to devices operating within the trusted computing environment, and
communicating the terms of use obtained from the lawful owners of the works to the local devices for regulating the further use of the lawfully protected works.

40. The method of claim 39 in which the step of providing access includes providing access through the local devices that enforce policies of a digital rights management system for regulating further use of the lawfully protected works accessed by the local devices.

41. The method of claim 40 in which the digital rights management system includes components that are embedded within the local devices.

42. The method of claim 39 in which the step of providing access to the lawfully protected works includes accepting payment for accessing at least a portion of one of the lawfully protected works.

43. The method of claim 42 in which the step of providing access to the lawfully unprotected works includes providing the access free of charge.

44. A method of providing limited access to copyright-protected works within a digital library system comprising steps of
processing a request by a remote user for access to a portion of a copyright-protected work stored in digital library system,
ascertaining a jurisdiction relevant to the request,
determining if fair-use provisions of the relevant jurisdiction govern the request, and
granting the user access to the requested portion of the copyrighted work without compensating the owner of the work when the request is governed by the fair-use provisions of the relevant jurisdiction and denying the user access to the requested portion of the copyrighted work without compensating the owner of the work when the request is not governed by the fair-use provisions of the relevant jurisdiction.

45. The method of claim 44 in which the step of ascertaining includes ascertaining a physical location of the remote user.

46. The method of claim 44 in which the step of ascertaining includes ascertaining a physical location from which access to the requested portion of the copyrighted work is to be granted.

47. The method of claim 44 in which the step of determining includes determining if national laws over the relevant jurisdiction include applicable fair-use provisions.

48. The method of claim 44 in which the step of determining includes determining how much of the requested portion of the copyright protected work can be lawfully accessed under the fair-use provisions of the relevant jurisdiction.

49. The method of claim 48 in which the step of granting includes granting the user access to less than all of the requested portion of the copyrighted work in accordance with the amount of the copyright protected work can be lawfully accessed under the fair-use provisions of the relevant jurisdiction.
